(19) United States
(12) Patent Application Publication
(10) Pub. No.: US 2004/0234862 A1
(43) Pub. Date: Nov. 25, 2004

(54) Battery separators

(76) Inventors: Graham Macglashan, Aberdeen (GB); Colin Marshall, Wigton (GB); Simon Read, Wigton (GB)

Correspondence Address: Wenderoth Lind & Ponack, Suite 800, 2033 K Street NW, Washington, DC, 20006, US

(21) Appl. No.: 10/477,181

(22) PCT Filed: Apr. 24, 2002
(86) PCT No.: PCT/EP02/04470

(30) Foreign Application Priority Data
May 10, 2001 (GB) 0111428.9
May 10, 2001 (GB) 0111427.1
May 10, 2001 (GB) 0111429.7
May 10, 2001 (GB) 0111426.3
May 10, 2001 (GB) 0111425.5

(51) Int. Cl. H01M 2/14; H01M 2/16

(52) U.S. Cl. 429/247; 429/254; 429/255

(57) ABSTRACT

There is described a battery separator comprising: a porous membrane (preferably of a cellulose film) having a mean thickness less than about 25 microns (preferably 15 microns) and optionally with one or more of the following properties: a) a tensile strength when dry (measured in the transverse direction of the membrane web) of greater than about 120 Nmm⁻²; b) a wet ionic resistance of less than about 20 mΩ.cm²; c) a membrane degree of polymerisation (D.P.) of greater than 350 chain units after being immersed for four hours in a bath of sodium hydroxide and hydrogen peroxide; and/or a) a tensile strength when dry (measured in the machine direction of the membrane web) of greater than about 200 Nmm⁻². Preferred membranes comprise biopolymeric films, such as films derived from cellulose and/or polylactic acid, more preferably a regenerated cellulosic film made using NMMO as regeneration liquid.

The invention relates to batteries and separators for use therein.

Batteries, such as alkaline batteries, are commonly used as energy sources. Generally, alkaline batteries have a cathode, an anode, a separator and an electrolytic solution. The cathode is typically formed of manganese dioxide, carbon particles and a binder. The anode can be formed of a gel including zinc particles. A separator is usually disposed between the cathode and the anode. The electrolytic solution, which is dispersed throughout the battery, can be a hydroxide solution. In the art the term “alkaline battery” is a commonly used to refer to a specific type of primary battery having the specific chemistry (gelled zinc/aqueous KOH/MnO₄). However as used herein the term “alkaline battery” is used more generally to mean any batteries which comprise an alkaline electrolyte. In fact it will be appreciated that the separators described herein may be used in any type of battery (e.g. primary or secondary) where a separator would be useful.

The separator is designed to allow good electrolyte ion flow between the anode and the cathode whilst reducing dendrite and soft shorting between the anode and cathode. Dendrite shorting refers to the situation where soluble salts or ions containing alkaline, alkaline earth or transition metals, such as potassium zincate, migrate between the electrodes of the battery and is reduced to the metal, e.g. zinc, on charging of the battery, resulting in an electrical connection between the anode and the cathode which can short out the external load. Soft shorting refers to the case when active material becomes solublised in the electrolyte solution and migrates away from the electrode, resulting in loss of capacity or reaction with active material of the other electrode. Zincate is a type of zinc oxide compound that can be formed in an alkaline battery under certain circumstances.

U.S. Pat. No. 6,159,634 (Duracell) describes batteries having a thin cellulose film as a separator. This reference teaches that thinness is the major requirement for improved separator performance. U.S. Pat. No. 6,159,634 does not appreciate many of the other properties necessary to provide a good separator and thus teaches that in the limit infinitely thin films would be acceptable. However thinness in the separator is not the only requirement to optimise battery performance. Not all thinner separators will exhibit better properties for battery used if one fails to consider and balance other competing properties required for the separator.

Thinner separators occupy a smaller volume inside the battery cell which increases the volume available for cathode material, anode material and/or electrolytic solution (active materials) in a batteries of a given standard size (e.g. AA, AAA, AAAA, C or D). The difference may be small as reducing the thickness of cellulose film component of the separator from 25 microns to 21 microns reduces the separator volume in a typical battery by about 14%, which this leads to an increase in the volume of active material of only 1%. A thinner film may also have a lower ionic resistance when wet. These effects together can result in a small improvement in battery performance if one compares thin separators with thicker ones identical apart from thickness.

However as one makes a thinner conventional separator there are some disadvantages which Increase the thinner the separator. The separator has a lower durability and strength, the separator web is more prone to break during production; the time taken to slit the separator (and its thinner component layers) is increased; production efficiency and throughput is reduced; and/or there is a reduced conversion efficiency of the component layers into separator (and separator into finished batteries). All of these factors can increase the production cost of using thinner separators and outweigh the small advantage in battery performance so gained.

A suitable separator comprises a biopolymer film, such as cellulosic film, especially a regenerated cellulose film as the porous membrane. One suitable separator construction comprises a laminate of a wicking layer adhered to a flat porous membrane. The membrane is selected with an average pore size which allows transport of electrolyte ions there across but blocks migration of undesirable ions such as zincate to thereby reduce dendrite and soft shorting. An example of a separator suitable for use in primary batteries is a non-woven layer comprising fibres laminated to a cellulosic film membrane. However any suitable configuration of separator may also be used for example in secondary batteries a cellulose film either alone or laminated to an asbestos mat and/or a porous polyolefin may be preferred.

The mechanical and physical properties of a separator laminate and both its component non woven and cellulose film layers must be such that they are durable when dry (so they can be handled and laminated as a web on a production machine). They also require sufficient strength and integrity when wet (especially in the alkaline electrolyte of an alkaline battery), especially if the separator is to be used in a rechargeable battery where it must survive the rigours of repeated cycles of charging and discharging. So a thinner separator even if it achieves low wet ionic resistance or allows greater volume of active material in the battery, it must also exhibit acceptable mechanical and other properties to provide the same or better overall battery performance than that obtained by a thicker film.

So the above factors must be balanced when producing thin separator film. Thus it can be seen that the demands on separator properties are varied and complex and cannot be reduced to a simplistic “the thinner the better” without considering other factors. It is desired to improve the properties of separators and the component layers thereof to overcome some or all of the problems with separators, for example with thin separators.

The applicant has surprisingly discovered that improved, optionally thinner, porous membrane (e.g. of cellulose film) can be made with good mechanical properties; and/or the optimal balance of certain separator properties can solve some or all of the problems with prior art separators during production and/or use.

Therefore broadly in accordance with the present invention there is provided a battery separator, comprising: a porous membrane having a mean thickness less than about 25 microns thick and a tensile strength when dry (measured in the transverse direction (TD) of the membrane web) of greater than about 120 Nmm⁻².

Preferably the TD dry tensile strength of the membrane is greater than about 130 Nmm⁻², more preferably greater than about 140 Nmm⁻²; most preferably greater than about 150 Nmm⁻².

Broadly in accordance with another aspect of the present invention there is provided a battery separator, comprising: a porous membrane (preferably of cellulose film) having a mean thickness when dry of less than about 25 microns and a wet ionic resistance of less than about 30 mΩ).cm², preferably less than about 20 mΩ.cm².

The wet ionic resistance (WIR) values given herein are those measured by conventional techniques known to those skilled in the art from an aqueous solution containing 40% potassium hydroxide (the WIR will vary at different KOH concentrations).

Broadly in accordance with yet another aspect of the present invention there is provided a battery separator, comprising: a porous membrane (preferably of cellulose film) having a mean thickness when dry of less than about 25 microns, the membrane exhibiting a degree of polymerisation (D.P.) of greater than 350 chain units preferably greater than about 500 after being subject to the oxidation test herein.

In the oxidation test, the film was immersed for four hours in a bath of sodium hydroxide and hydrogen peroxide. This test simulates in a few hours; many years of exposure to the conditions in an alkaline battery. The DP can be measured and/or calculated by any suitable technique such as GPC.

Broadly in accordance with still another aspect of the present invention there is provided a battery separator, comprising: a porous membrane having a mean thickness when dry of less than about 15 microns.

Preferably the membrane films have a mean dry thickness from about 5 microns to about 14 microns, more preferably from about 8 microns to about 12 microns.

Preferably the membrane has a mean thickness when dry of less than about 11 microns.

Broadly in accordance with yet still another aspect of the present invention there is provided a battery separator, comprising: a porous membrane (preferably of cellulose film) having a mean thickness when dry of less than about 25 microns and a tensile strength when dry (measured in the transverse direction (TD) of the membrane web) of greater than about 120 Nmm⁻²; a wet ionic resistance of less than about 30 mΩ.cm²., and where the membrane exhibiting a degree of polymerisation (D.P.) of greater than 350 chain units after being subject to the oxidation test herein.

Preferably these membrane films have a tensile strength of greater than about 200 Nmm⁻²; more preferably greater than about 250 N/mm², most preferably greater than about 300 N/mm² and of the dry membrane (measured in the machine direction (MD) of the membrane web) is greater than about 200 Nmm⁻², more preferably greater than about 250 Nmm⁻²; most preferably greater than about 280 Nmm⁻²; advantageously greater than about 300 Nmm⁻², and more advantageously greater than about 350 Nmm⁻².

Preferably the wet ionic resistance of the membrane is less than about 20 mΩ.cm².

Further aspects of the invention and preferred features and integers thereof are given in the claims herein which are incorporated by reference into this specification.

Separators of and used in the present invention comprises material(s) that can form a porous preferably semi-permeable sheet and are substantially inert to the electrolytic solution and capable of reducing dendrite shorting so the separator allows ion transport thereacross for good ion flow between the cathode and anode. Usually, the separator and any component layers thereof do not include wettable material coatings, metal coatings or fillers such as, for example, inorganic particles.

A typical separator construction comprises a laminate of a wicking layer (for example a nonwoven layer comprising fibres) adhered to a porous membrane (for example a cellulosic film). In a preferred embodiment, the laminate is made according to the method disclosed in U.S. Pat. No. 4,902,590, which is hereby incorporated by reference.

Porous Membrane

Suitable membrane materials comprise polyvinyl alcohol (PVA), polysulphones, grafted polypropylene, polyamides and biopolymers having the desired properties herein. Types of membrane forming biopolymers that may be used (after where necessary suitable modification) are described below. It is preferred than the membranes are naturally porous rather than mechanically perforated.

The biopolymeric films which may be used in present invention may be obtained and/or obtainable from a biological (preferably plant and/or microbial) source and may comprise those organic polymers which comprise substantially carbon, oxygen and hydrogen. Conveniently biopolymers may be selected from carbohydrates; polysaccharides (such as starch, cellulose, glycogen, hemi-cellulose, chitin, fructan inulin; lignin and/or pectic substances); gums; proteins, optionally cereal, vegetable and/or animal proteins (such as gluten [e.g. from wheat], whey protein, and/or gelatin); colloids (such as hydro-colloids, for example natural hydrocolloids, e.g. gums); other polyorganic acids (such as polylactic acid and/or polygalactic acid) effective mixtures thereof; and/or effective modified derivatives thereof.

Further details of each of these biopolymers are given below.

Starch may comprises native and/or modified starch obtained and/or obtainable from one or more plant(s); may be a starch, starch-ether, starch-ester and/or oxidised starch obtained and/or obtainable from one or more root(s), tuber(s) and/or cereal(s) such as those obtained and/or obtainable from potato, waxy maize, tapioca and/or rice.

Gluten may comprise a mixture of two proteins, gliadin and glutenin whose amino acid composition may vary although glutamic acid and proline usually predominate.

Gums are natural hydro-colloids which may be obtained from plants and are typically insoluble in organic solvents but form gelatinous or sticky solutions with water. Gum resins are mixtures of gums and natural resins.

As used herein the term carbohydrate will be understood to comprise those compounds of formula Cₓ(H₂O)_{y}. which may be optionally substituted. Carbohydrates may be divided into saccharides (also referred to herein as sugars) which typically may be of low molecular weight and/or sweet taste and/or polysaccharides which typically may be of high molecular weight and/or

Polysaccharides comprise any carbohydrates comprising one or more monosaccharide (simple sugar) units. Homopolysaccharides comprise only one type of monosaccharide and heteropolysaccharides comprise two or more different types of sugar. Long chain polysaccharides may have molecular weights of up to several million daltons and are often highly branched, examples of these polysaccharides comprise starch, glycogen and cellulose. Polysaccharides also include the more simple disaccharide sugars, trisaccharide sugars and/or dextrins (e.g. maltodextrin and/or cyclodextrin).

Polysaccharides may comprise a polymer of at least twenty or more monosaccharide units and more preferably have a molecular weight (M_{w}) of above about 5000 daltons. Less complex polysaccharides comprise disaccharide sugars, trisaccharide sugars, maltodextrins and/or cyclodextrins.

Complex polysaccharides which may be used as biopolymers to form or comprise films of present invention comprise one or more of the following: Starch (which occurs widely in plants) may comprise various proportions of two polymers derived from glucose: amylose (comprising linear chains comprising from about 100 to about 1000 linked glucose molecules) and amylopectin (comprising highly branched chains of glucose molecules). Glycogen (also known as animal starch ) comprises a highly branched polymer of glucose which can occur in animal tissues. Cellulose comprises a long unbranched chain of glucose units. Chitin comprises chains of N-acetyl-D-glucosamine (a derivative of glucose) and is structurally very similar to cellulose. Fructans comprise polysaccharides derived from fructose which may be stored in certain plants. Inulin comprises a polysaccharide made from fructose which may be stored in the roots or tubers of many plants. Lignin comprises a complex organic polymer that may be deposited within the cellulose of plant cell walls to provide rigidity. Pectic substances such as pectin comprise polysaccharides made up primarily of sugar acids which may be important constituents of plant cell walls. Normally they exist in an insoluble form, but may change into a soluble form (e.g. during ripening of a plant). Polylactic and/or polygalactic polymers and the like comprise those polymeric chains and/or cross-linked polymeric networks which are obtained from, obtainable from and/or comprise: polylactic acid; polygalactic acid and/or similar polymers and which may be made synthetically and/or sourced naturally.

Other types of polysaccharide derivatives one or more of which may also be used in the present invention may comprise any effective derivative of any suitable polysaccharide (such as those described herein) for example those derivatives selected from amino derivatives, ester derivatives (such as phosphate esters) ether derivatives; and/or oxidised derivatives (e.g. acids).

Preferred biopolymer films used in the present invention are those formed from a biopolymer selected from cellulose, cellulose derivatives (such as cellulose acetate) and/or polylactic acid.

As used herein the term “regenerated cellulose” is used to encompass both cellulose film which has been produced by regeneration from a derivative of cellulose (such as cellulose xanthate (viscose) or cellulose acetate) and also films referred to as “coagulated” were the cellulose film is produced from a dispersion or solution containing cellulose itself (such as NMMO or LiCl/DMA). Cellulosic refers both to cellulose itself and suitable derivatives thereof.

Preferably the cellulosic film used in the present invention is regenerated from a cellulosic dispersion in a fluid which is preferably non-solvating. Suitable fluids may include but are not limited to: N-methylmorpholine N-oxide (NMMO) and suitable derivatives thereof; and/or mixtures of lithium halides (such a lithium chloride) with polar aprotic amide solvents (such as dimethylpropionamide (DMP), N,N-dimethylimidazolidinone (DMI) and/or N,N- dimethylacetamide (DMA)):

Another example of a cellulose in a solvating fluid is “viscose” which is sodium cellulose xanthate in caustic soda. Cellulose from a dispersion can be cast into film by regenerating the cellulose in situ by a suitable treatment (e.g. addition of suitable reagent which for viscose can be dilute sulphuric acid) and optionally extruding the cellulose thus formed. Such cellulose is known herein as regenerated cellulose and preferred films of the present invention comprise regenerated cellulose.

More preferred biopolymer films used as the separator membrane comprise cellulose which is substantially continuous, more preferably non-woven and/or entangled, in structure, most preferably non woven. Especially preferred films comprises non-microbial cellulose.

Conveniently films used in the present invention substantially comprise cellulose from a wood source and/or cotton linters, most preferably at least 90% of the cellulosic material is from a wood source.

The membrane layer may include one or more plasticizers, but, typically, such plasticizers are not included. Generally the membrane is a porous layer that does not include wettable material coatings, metal coatings or fillers such as, for example, inorganic particles.

Adhesive

The adhesive may comprise any material that is substantially inert to the electrolytic solution and that can form a physical and/or chemical bond between the wicking layer and porous membrane sufficient that separator forms an integrated unit without increasing the barrier to good ion flow. Suitable materials especially for use in alkaline batteries, comprise polyacrylic acids (such as that available commercially from B. F. Goodrich under the trade name Carbopol 940), grafted starch materials (such as that available commercially from Grain Processing Corporation, Muscatine, Iowa under the trade name Waterlock A221), carboxymethylcellulose and mixtures thereof. The amount of material in the adhesion layer is preferably less than about 6 gm⁻², more preferably from about 1 gm⁻² to about 5 gm⁻², and most preferably about 3 gm⁻²

Wicking Layer

The wicking layer is designed to improve the flow of electrolyte through the membrane. Preferred wicking layers may be formed of one or more nonwoven materials (such as cellulose, PVA, polyamides, polysulphones and mixtures thereof) optionally having fibres thereon or optionally perforated non porous film such as polyolefinic film. More preferably the nonwoven layer comprises a matrix of PVA fibres; PVA binder; cellulose fibres (for example those fibres available commercially from Courtalds under the trade marks Tencel and/or Lyocel) and/or rayon fibres. The cellulose fibres may be about 1.5 denier at 6 millimetres long, and the PVA fibres may be about 0.5 denier at 6 millimetres long. Optionally the non woven layer may comprise from about 20% to about 40% (for example about 30%) by weight of rayon and/or cellulose fibres; from about 55% to about 65% by weight (for example about 57%) of PVA fibres; and/or from about 5% to about 15% (for example 13%) by weight of PVA binder.

The contents of U.S. Pat. No. 6,159,634 are hereby incorporated by reference for the other preferred features of the separators (and components thereof) and batteries of the invention. The preferred batteries are alkaline batteries that have a thin separator for example with a general construction as disclosed in any of the embodiments or drawings of U.S. Pat. No. 6,159,634 (Duracell).

The invention will now be illustrated by the following non-limiting examples.

### EXAMPLE 1

Cellulose Film

A regenerated cellulose film was prepared by the known method of regeneration from a dope bath comprising 13% cellulose in N-methyl-morpholine N-oxide (also known as NMMO) and as described in for example U.S. Pat. No. 4,226,221 and elsewhere. The film was extruded through a slot die under the following conditions to obtain a porous membrane of the invention having the properties described herein: die gap=50 microns; dope flow rate 112 litres per hour; MD draw ratio 0.51; and TD draw ratio 3.0. This gave a cellulose film having a dry thickness of 12 microns with a tensile strength in the TD of 122 N/mm²; and a wet ionic resistance of about 27 mΩ.cm². After this cellulose film was immersed for four hours in a bath of sodium hydroxide and hydrogen peroxide the DP of the film was determined to be greater than 500 chain units.

### EXAMPLE 2

Battery and Battery Separator

A battery and a preferred laminated separator of the invention may be prepared as described in any of the Examples of U.S. Pat. No. 6,519,634 (Duracell) where the UCB P300 cellulose films used therein are replaced by with the cellulose film of the invention described in Example 1. The battery separators so formed exhibit superior performance compared to prior art separators. Without wishing to be bound by any mechanism it is believed that this may be due to the high DP of the film of Example 1 which has been stentered (stretched in both the TD and MD).

1. A battery separator, comprising: a substantially flat, porous membrane having a mean thickness less than about 25 microns thick where the membrane has at least one of the following further properties:
a) a tensile strength when dry, as measured in the transverse direction (TD) of the membrane web, of greater than about 120 Nmm⁻².
b) a wet ionic resistance of less than about 30 mΩcm²,
c) a degree of polymerisation (DP) of greater than 350 chain units after being immersed for four hours in a bath of sodium hydroxide and hydrogen peroxide.
d) a mean thickness less than about 15 microns: and/or
e) a tensile strength when dry as measured in the machine direction (MD) of the membrane, of greater than about 200 Nmm⁻².

2. A battery separator as claimed in claim 1, where the membrane has at least two of the properties a) to e).

3. A battery separator as claimed in claim 2, where the membrane has at least three of the properties a) to e).

4. A battery separator as claimed in claim 3, where the membrane has at least four of the properties a) to e).

5. A battery separator as claimed in claim 4, where the membrane has all five of the properties a) to e).

6. A separator according to claim 1, in which the TD dry tensile strength of the membrane is greater than about 120 Nmm⁻².

7. A separator according to claim 6, in which the TD strength of the membrane is greater than about 130 Nmm⁻².

8. A separator according to claim 7, In which the TD strength is greater than about 140 Nmm⁻².

9. A separator according to claim 8, in which the TD strength is greater than about 150 Nmm⁻².

10. A separator according to claim 1, which has a wet ionic resistance of less 40 than about 30 mΩcm².

11. A separator according to claim 10, with a resistance less than about 20 mΩcm².

12. A separator according to claim 1, which has a OP of greater than 350 chain units after being immersed for four hours in a bath of sodium hydroxide and hydrogen peroxide.

13. A separator according to claim 12, which has a DP of greater than 500 chain units.

14. A separator according to ally preceding claim 1, in which the membrane has a mean dry thickness of less than about 15 microns

15. A separator according to claim 14, in which the membrane is less than about 11 microns thick.

16. A separator according to claim 1, in which the membrane has a mean dry thickness of from about 5 microns to about 14 microns.

17. A separator according to claim 16, in which the membrane is from about 8 microns to about 12 microns thick.

18. A separator according to claim 1, in which the MD dry tensile strength of the membrane is greater than about 200 Nmm⁻².

19. A separator according to claim 18, in which the MD strength is greater than about 250 Nmm⁻².

20. A separator according to claim 19, in which the MD strength is greater than about 280 Nmm⁻².

21. A separator according to claim 20, in which the MD strength is greater than about 300 Nmm⁻².

22. A separator according to claim 21, in which the MD strength is greater than about 350 Nmm⁻².

23. A separator according to claim 1, in which the membrane comprises a biopolymeric film.

24. A separator according to claim 23, In which the biopolymeric film comprises a film derived from cellulose, cellulose derivatives (such as cellulose acetate) and/or polylactic acid.

25. A separator according to claim 24, which comprises a regenerated cellulosic film.

26. A separator according to claim 25, in which the cellulosic film is regenerated from a fluid selected from:
i) N-methylmorpholine N-oxide (NMMO) and suitable derivatives thereof; and/or
ii) a suitable mixture of a lithium halide (such a lithium chloride) with a polar, aprotic amide solvent (such as dimethylpropionamide (DMP), N,N-dimethylimidazolidinone (DMI) and/or N,N-dimethylacetamide (DMA)):

27. A separator according to claim 26, in which the fluid is NMMO and/or a LiCl/DMP mixture.

28. A separator according to claim 27, in which the cellulose film is regenerated from a dope bath comprising a concentration of at least 10% by weight of cellulose in NMMO,

29. A separator according to claim 28, in which the cellulose concentration in the dope is from about 10% to about 15%.

30. A separator according to claim 29, in which the cellulose concentration in the dope is about 13%.

31. A separator according to claim 25, in which the cellulose film is regenerated under at least one of the following conditions:
a) extrusion from the regenerating fluid at a flow rate of at least 100 litres per hour;
b) extrusion through a slot-die of gap less than about 60 microns;
c) a web draw ratio in the machine direction of at least 0.4 and/or
d) a web draw ratio in the transverse direction of at least 2.5.

32. A separator as claimed in claim 1 which further comprises a wicking layer to improve the flow of electrolyte ions through the membrane,

33. A separator as claimed in claim 32, where the wicking layer comprises one or more nonwoven materials optionally having fibres thereon.

34. A separator as claimed in claim 32, where the wicking layer comprises cellulose, PVA, polyamides, polysuiphones, perforated polyolelinic film and/or mixtures thereof.

35. A separator as claimed in claim 32 in which the wicking layer is laminated to the membrane with an inert adhesive.

36. A separator as claimed in claim 35, in which the adhesive comprises polyacrylic acid grafted starch materials, carboxymethyl cellulose and/or mixtures thereof

37. A battery separator obtained and/or obtainable by a process comprising at least one of the features described in claim 26.

38. A porous membrane having a mean thickness less than about 25 microns thick where the membrane has at least one of the following further properties:
a) a tensile strength when dry as measured in the transverse direction (TD) of the membrane web of greater than about 120 Nmm⁻².
b) a wet ionic resistance of less than about 30 mΩcm².
c) a degree of polymerisation (DP) of greater than 350 chain units after being immersed for four hours in a bath of sodium hydroxide and hydrogen peroxide.
d) a mean thickness less than about 15 microns: and/or
e) a tensile strength when dry as measured in the machine direction (MD) of the membrane, of greater than about 200 Nmm⁻² obtained and/or obtainable by a process comprising at least one of the features described in claim 26.

39. A battery comprising a separator comprising a substantially flat, porous membrane having a mean thickness less than about 25 microns thick where the membrane has at least one of the following further properties:
a) a tensile strength when dry, as measured in the transverse direction (TD) of the membrane web, of greater than about 120 Nmm⁻².
b) a wet ionic resistance of less than about 30 mΩcm²,
c) a degree of polymerisation (DP) of greater than 350 chain units after being immersed for four hours in a bath of sodium hydroxide and hydrogen peroxide.
d) a mean thickness less than about 15 microns: and/or
e) a tensile strength when dry as measured in the machine direction (MD) of the membrane, of greater than about 200 Nmm⁻² and/or a membrane produced from a fluid selected from:
i) N-methylmorpholine N-oxide (NMMO) and suitable derivatives thereof, and/or
ii) a suitable mixture of a lithium halide (such as lithium chloride) with a polar, aprotic amide solvent (such as dimethylpropionamide (DMP), N,N-dimethylimidazolidinone (DMI) and/or N,Ndimethylacetamide (DMA)).

40. A battery powered device comprising at least one battery as claimed in claim 39.

41. A method of making a battery and/or battery powered device comprising incorporating therein a separator as claimed in claim 1 and/or a membrane obtained or obtainable by a process in which a cellulose film is regenerated from a fluid selected from:
i) N-methylmorpholine N-oxide (NMMO) and suitable derivatives thereof; and/or
ii) a suitable mixture of a lithium halide (such a lithium chloride) with a polar, aprotic amide solvent (such as dimethylpropionamide (DMP), N,N-dimethylimidazolidinone (DMI) and/or N,Ndimethylacetamide (DMA)):.

42. (Cancelled).

43. A process for making a separator; membrane, battery and/or device comprising a cellulose film regenerated from a fluid selected from:
i) N-methylmorpholine N-oxide (NMMO) and suitable derivatives thereof; and/or
ii) a suitable mixture of a lithium halide (such a lithium chloride) with a polar, aprotic amide solvent (such as dimethylpropionamide (DMP), N,N-dimethylimidazolidinone (DMI) and/or N,Ndimethylacetamide (DMA)):.

44. (Cancelled).
